(19) United States
(12) Patent Application Publication
(10) Pub. No.: US 2023/0051603 A1
(43) Pub. Date: Feb. 16, 2023

(54) Module Active Response System

(71) Applicant: Ecolution kWh, LLC, Naples, FL (US)

(72) Inventors: Johnny Then-Gautier, Santo Domingo (DO); Johanne G. Then Medina, Naples, FL (US)

(21) Appl. No.: 17/974,647

(22) Filed: Oct. 27, 2022

Related U.S. Application Data
(63) Continuation-in-part of application No. 16/871,281, filed on May 11, 2020, now Pat. No. 11,485,235.
Application No. 16/871,281 is a continuation of application No. 15/858,848, filed on Dec. 29, 2017, now Pat. No. 10,668,814.
(60) Provisional application No. 62/440,775, filed on Dec. 30, 2016.

(51) Int. Cl. B60L 7/10; F16D 55/226; H02K 7/102

(52) U.S. Cl. CPC B60L 7/10; F16D 55/226; H02K 7/102; B60L 2220/44

(57) ABSTRACT

A system for the supplemental generation of energy from the operation of a vehicle operation, and specifically to the generation of energy in connection with a vehicle's drum brakes in combination with brushless electric motor-generators. The system includes a rotational conveyor that operatively connects the drum to a coupler member attached to a generator so that rotation of the drum rotates the coupler member to create energy. A frame member may position and retain the generator in place relative to the drum.

### CROSS-REFERENCE TO RELATED APPLICATIONS

This application is a continuation-in-part of U.S. non-provisional patent application Ser. No. 16/871,281, filed on May 11, 2020, which is a continuation of pending U.S. Non-Provisional patent application Ser. No. 15/858,848 titled “Module Active Response System”, filed on Dec. 29, 2017 and issued as U.S. Pat. No. 10,668,814 on Jun. 2, 2020, which claims benefit to U.S. provisional patent application Ser. No. 62/440,775 titled “Module Active Response System”, filed on Dec. 30, 2016, the disclosure of all of which are herein incorporated by reference in their entirety.

### PATENTS CITED

The following documents and references are incorporated by reference in their entirety, Erlston et al (U.S. Pat. Appl. No. 2008/0078631) and Bodenstein et al (U.S. Pat. Appl. No. 2012/0091724).

### FIELD OF THE INVENTION

The present invention relates to the supplemental generation of energy from a vehicle operation, and specifically to the generation of energy from vehicle brakes in combination with brushless electric motor-generators.

### DESCRIPTION OF THE RELATED ART

A vehicle's motion requires a large amount of energy to be accomplished, and an almost equal amount of energy (minus transmission losses) is released when the vehicle is stopped. In recent times, hybrid and other vehicles have used the electric motors located at the wheels to regenerate energy when braking is applied. In the same way, some of the energy spent to make the vehicle move can be recuperated.

Vehicles typically utilize one or two types of brakes, namely, disc brakes and drum brakes. Vehicles equipped with disc brakes (e.g., automotive, rail vehicle, light aircraft and other similar applications) employ a rotor located on the axle or wheel hub and a caliper mechanism that clamps brake pads against both sides of the rotor, creating friction and generating braking force. In most commercial and military aircraft, multiple rotors are connected, with ventilating slots between them. In conventional disc brake usage, a vehicle's kinetic energy is dissipated as heat when the brakes are applied.

Drum brakes utilize a drum that rotates with the axle and wheel. When the brakes are applied, fluid is sent to a wheel cylinder, which activates pistons that push a pair of opposed brake shoes outwardly against the inside of the drum. The shoes each include a friction liner such that when the shoes engage the drum, they apply friction to slow and stop rotation of the drum and, thus the wheels. Similar to a disc brake, braking using a drum brake generates heat from the friction between the shoes and the drum that is dissipated as heat.

The ability to generate electricity from the rotation of the braking components would be advantageous in that a battery would be charged, therefore obviating the need for the vehicle alternator to operate. What is required is a simple mechanical way in which to couple to the rotational braking elements.

### SUMMARY OF THE INVENTION

This section is for the purpose of summarizing some aspects of the present invention and to briefly introduce some embodiments. Simplifications or omissions may be made to avoid obscuring the purpose of the section. Such simplifications or omissions are not intended to limit the scope of the present invention.

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e., that it will be taken to mean an inclusion of not only the listed components it directly references, but also other non-specified components or elements. This rationale will also be used when the term ‘comprised’ or ‘comprising’ is used in relation to one or more steps in a method or process.

In one aspect, the invention is about a vehicle energy apparatus comprising a generator coupled to a shaft, said shaft having mechanical components for coupling with a disc ventilating slot and electronic components for connecting said generator to a vehicle's electrical system.

In another embodiment of the invention, the system for the supplemental generation of energy is used in connection with a vehicle's drum brakes in combination with brushless electric motor-generators. The system includes a rotational conveyor that operatively connects the drum to a coupler member attached to a generator so that rotation of the drum rotates the coupler member to create energy. A frame member may position and retain the generator in place relative to the drum.

Other features and advantages of the present invention will become apparent upon examining the following detailed description of an embodiment thereof, taken in conjunction with the attached drawings.

### BRIEF DESCRIPTION OF THE DRAWINGS

FIG. 1 is a front perspective view showing the components of a disc brake system, according to the prior art.

FIG. 2 is a perspective view of a coupled disc brake and generator, according to an exemplary embodiment of the invention.

FIG. 3 is a rear view of a coupled disc brake and generator, according to an exemplary embodiment of the invention.

FIG. 4 is a perspective view of a coupled disc brake and generator including a vehicle tire, according to an exemplary embodiment of the invention.

FIGS. 5 and 6 are top views of the coupled disc brake and generator, according to exemplary embodiments of the invention.

FIGS. 7 and 8 are side views of the disc brake and bracket, according to exemplary embodiments of the invention.

FIGS. 9 and 10 are perspective views of the disc brake and generator components, according to exemplary embodiments of the invention.

FIG. 11 is a perspective view of a chained and coupled disc brake and generator including the wheel hub, according to an exemplary embodiment of the invention.

FIG. 12 is a perspective view of a chained and coupled disc brake and generator, according to an exemplary embodiment of the invention.

FIG. 13 is a front view of a chained and coupled disc brake and generator, according to an exemplary embodiment of the invention.

FIG. 14 is a side view of a chained and coupled disc brake and generator, according to an exemplary embodiment of the invention.

FIG. 15 is a top view of a chained and coupled disc brake and generator, according to an exemplary embodiment of the invention.

FIG. 16 is a partially exploded perspective view of a chained and coupled disc brake and generator, according to an exemplary embodiment of the invention.

FIG. 17 is a sectional side view taken along the line B-B of FIG. 18 of a chained and coupled disc brake and generator, according to an exemplary embodiment of the invention.

FIG. 18 is a front view of a chained and coupled disc brake and generator, according to an exemplary embodiment of the invention.

FIG. 19 is a partial sectional view of a disc brake coupled with a chain, according to an exemplary embodiment of the invention.

FIG. 20 is a partial sectional view of the sprocket coupled with the chain, according to an exemplary embodiment of the invention.

FIG. 21 is a top view of the sprocket, according to exemplary embodiments of the invention.

FIG. 22 is a side view of the sprocket, according to exemplary embodiments of the invention.

FIG. 23 is a top plan view of the axle and jaw member of the clutch.

FIG. 24 is a side view of the axle and jaw member of the clutch.

FIG. 25 is a top plan view of the generator shaft or driven member of the clutch.

FIG. 26 is a side view of the generator shaft or driven member of the clutch.

FIG. 27 is a top plan view of the jaw member of the clutch.

FIG. 28 is a side view of the jaw member of the clutch.

FIGS. 29A-29C show various views of the sprocket, according to exemplary embodiments of the invention.

FIGS. 30A-30E show various views of the disk assembly components, according to exemplary embodiments of the invention.

FIGS. 31-32 show various views of the axle and clutch, according to exemplary embodiments of the invention.

FIG. 33 is a perspective view of a coupled disc brake and generator, according to another exemplary embodiment of the invention.

FIG. 34 is a front perspective view of a coupled disc brake and generator, according to another exemplary embodiment of the invention.

FIG. 35 is a cross-sectional side view of a coupled disc brake and generator, according to another exemplary embodiment of the invention.

FIG. 36 is a partial perspective view of a coupler engaging a chain around the disc brake rotor, according to an exemplary embodiment of the invention.

FIG. 37 is a partial perspective view of a coupler engaging a chain around the disc brake rotor and showing a clutch, according to an exemplary embodiment of the invention.

FIG. 38 is a front perspective view showing the components of a drum brake system, according to the prior art.

FIG. 39 is a partial perspective view of a pair of coupled drum brakes and generators in a vehicle, according to an exemplary embodiment of the invention.

FIG. 40 is a partial exploded view of the coupled drum brake and generator of FIG. 39 with the wheel.

FIG. 41 is a partial exploded view of the coupled drum brake and generator of FIG. 40.

The above-described and other features will be appreciated and understood by those skilled in the art from the following detailed description, drawings, and appended claims.

### DETAILED DESCRIPTION OF THE INVENTION

This section is for the purpose of summarizing some aspects of the present invention and to briefly introduce some embodiments. Simplifications or omissions may be made to avoid obscuring the purpose of the section. Such simplifications or omissions are not intended to limit the scope of the present invention.

To provide an overall understanding of the invention, certain illustrative embodiments and examples will now be described. However, it will be understood by one of ordinary skill in the art that the same or equivalent functions and sequences may be accomplished by different embodiments that are also intended to be encompassed within the spirit and scope of the disclosure. The compositions, apparatuses, systems and/or methods described herein may be adapted and modified as is appropriate for the application being addressed and that those described herein may be employed in other suitable applications, and that such other additions and modifications will not depart from the scope hereof.

Simplifications or omissions may be made to avoid obscuring the purpose of the section. Such simplifications or omissions are not intended to limit the scope of the present invention. All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art.

As used in the specification and claims, the singular forms “a”, “an” and “the” include plural references unless the context clearly dictates otherwise. For example, the term “a transaction” may include a plurality of transaction unless the context clearly dictates otherwise. As used in the specification and claims, singular names or types referenced include variations within the family of said name unless the context clearly dictates otherwise.

Certain terminology is used in the following description for convenience only and is not limiting. The words “lower,” “upper,” “bottom,” “top,” “front,” “back,” “left,” “right” and “sides” designate directions in the drawings to which reference is made, but are not limiting with respect to the orientation in which the modules or any assembly of them may be used.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Referring to FIG. 1, a disc brake system as presently embodied in the prior art is shown with a disc or disk brake rotor 100 that has ventilating slots 102 circumferentially positioned about the center of the disc or disk brake rotor 100. A brake caliper 104 having a hollow interior defined by a pair of side portions 106, 108 is positioned astride of the disc brake rotor 100. Positioned within the hollow interior on the inside of the side portions 106, 108 are a pair of brake pads 110 sized to engage a portion of the outer surfaces of the disc brake rotor 100. A guide pin 112 located at one end of the brake caliper 104 allows the brake caliper 104 to be squeezed, thereby moving the brake pads 110 into engagement with the disc brake rotor 100. An inspection hole 114 on the top of the brake caliper 104 allows for the brake pads 110 to be viewed to determine their relative wear. The disc brake rotor 110 is connected to the wheels through the wheel hub 116 and wheel studs 118.

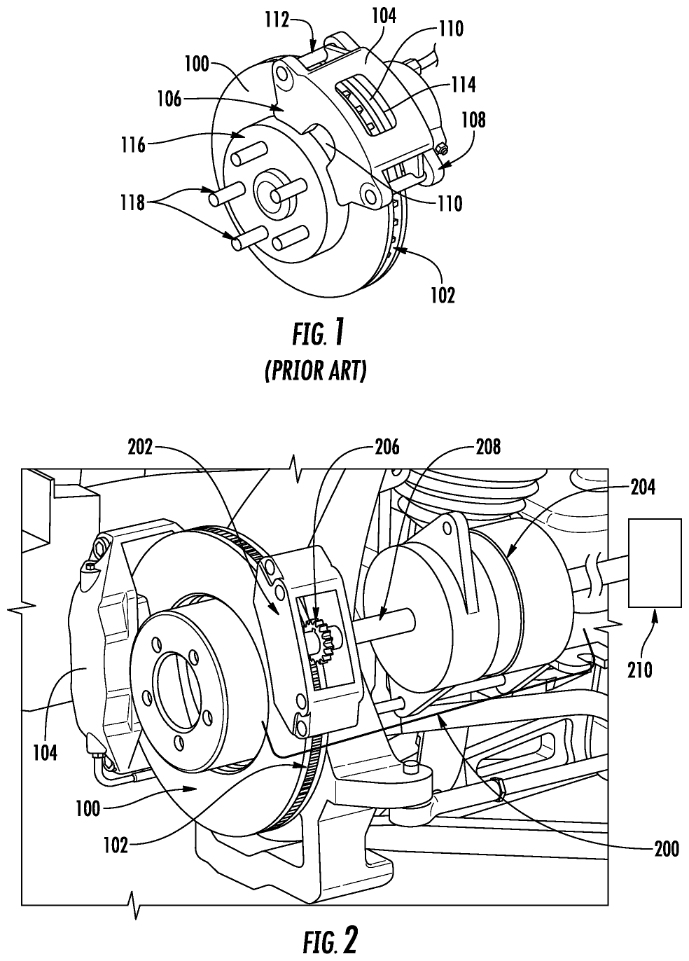

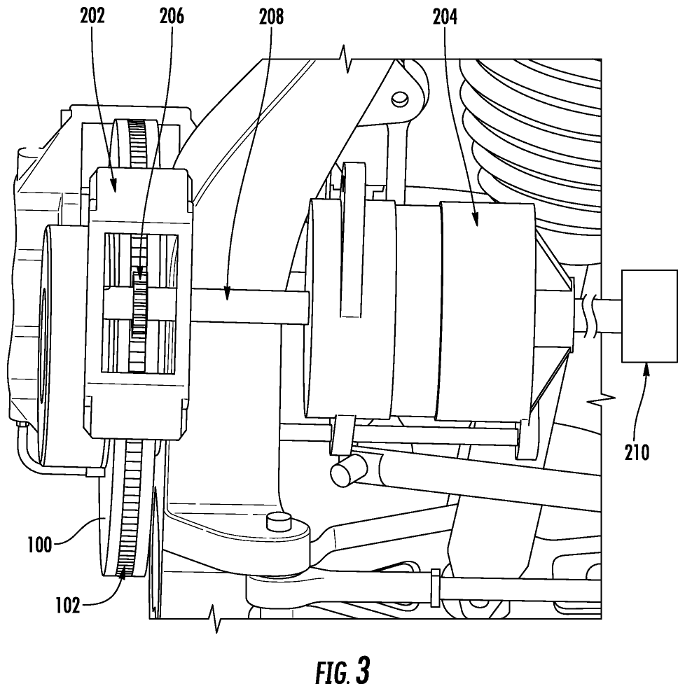

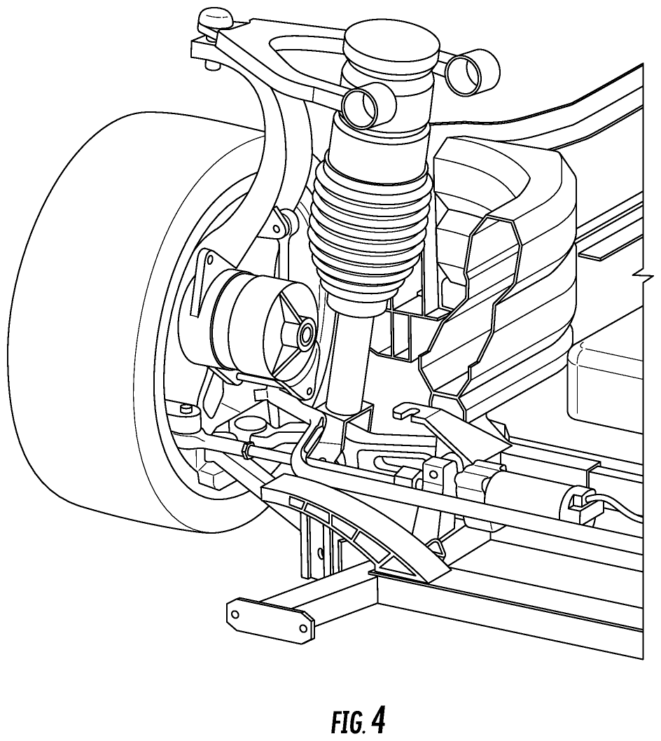

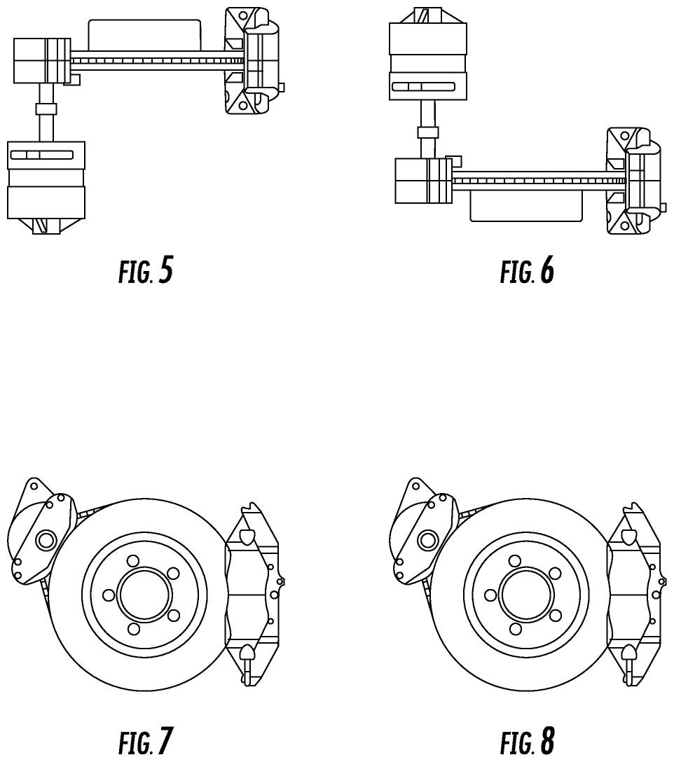

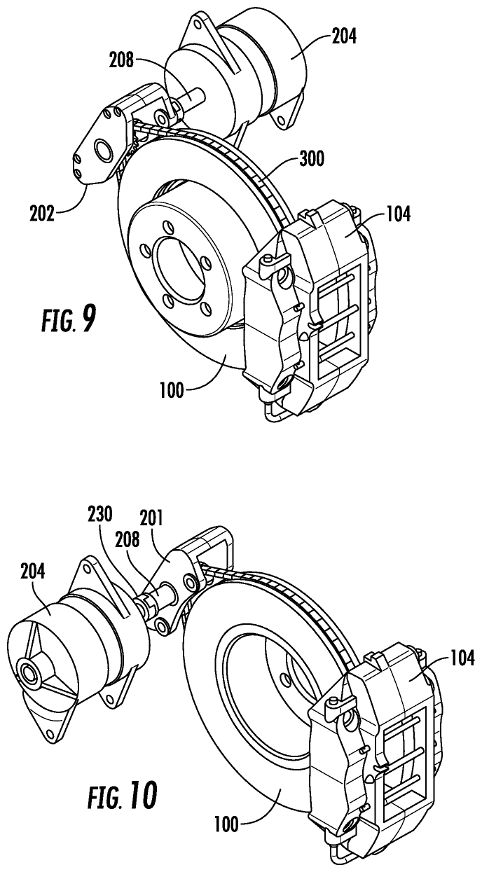

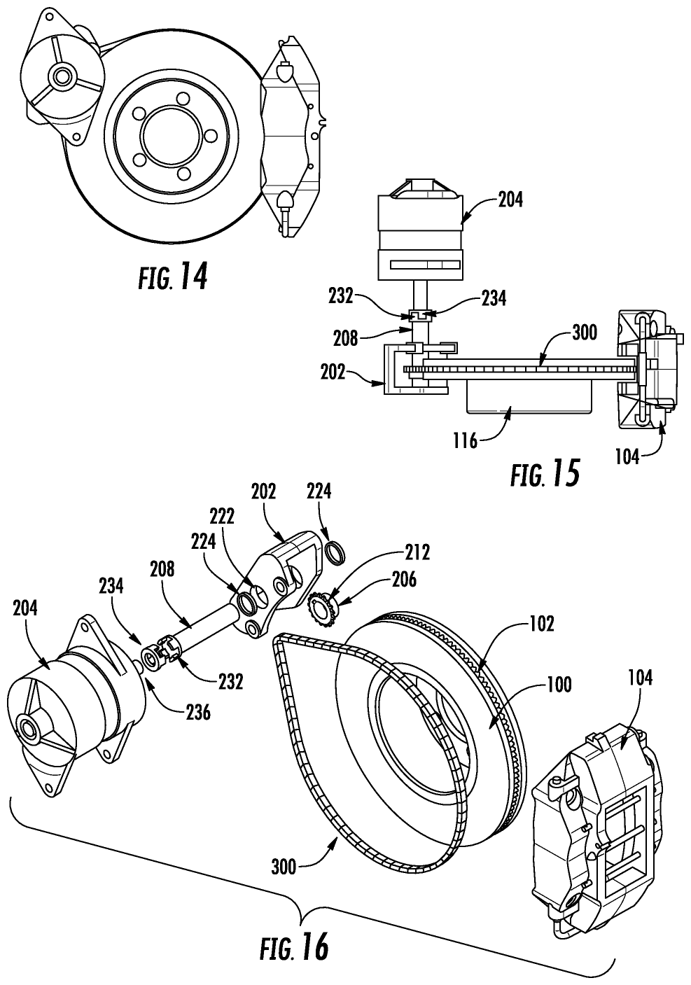

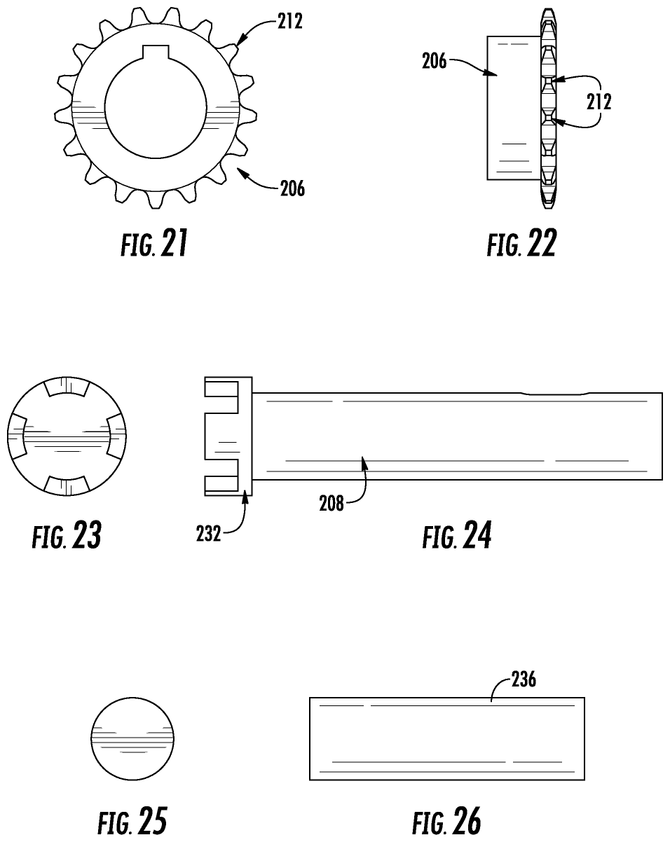

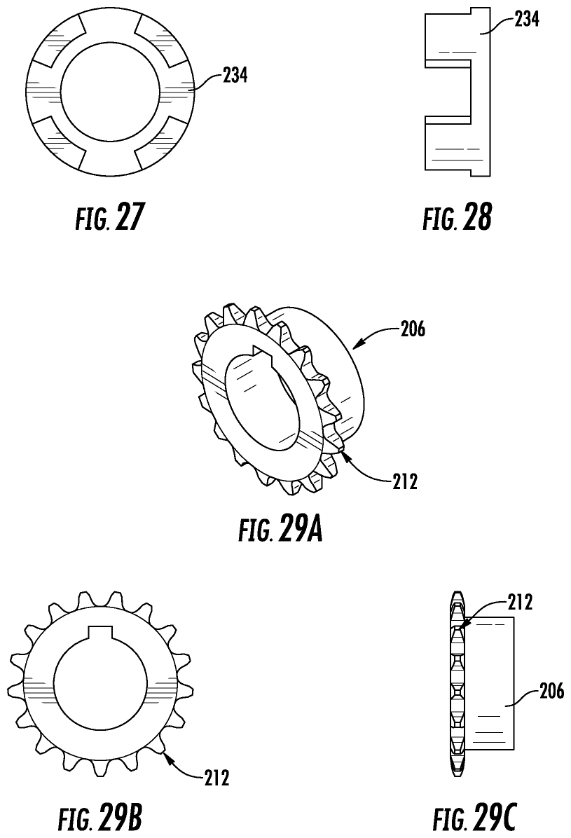

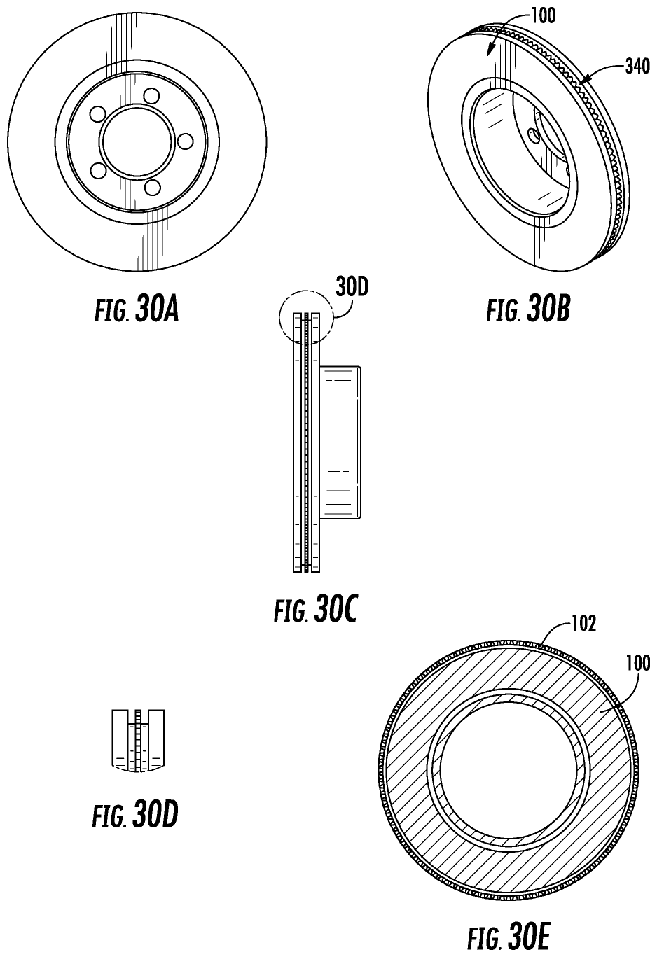

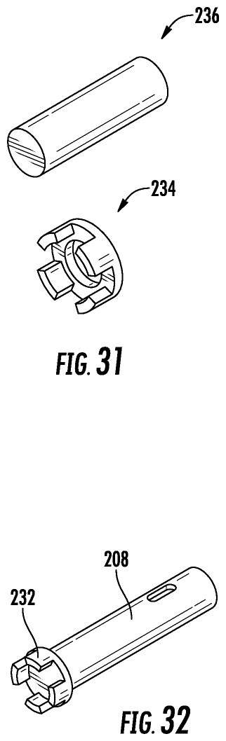

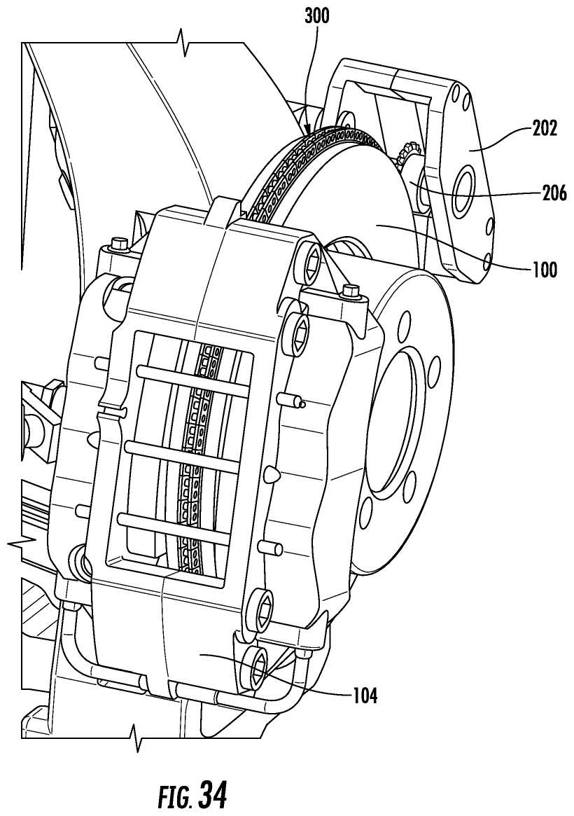

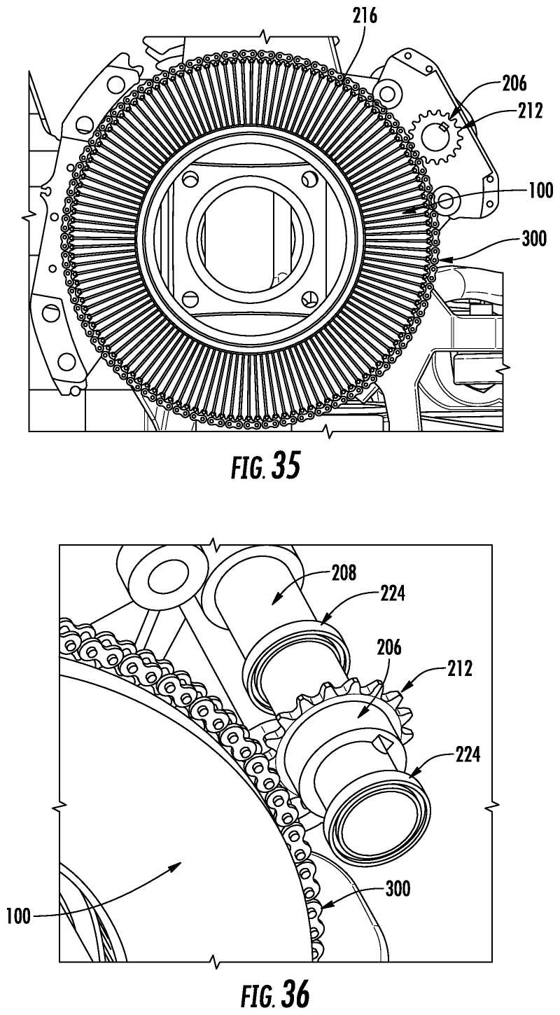

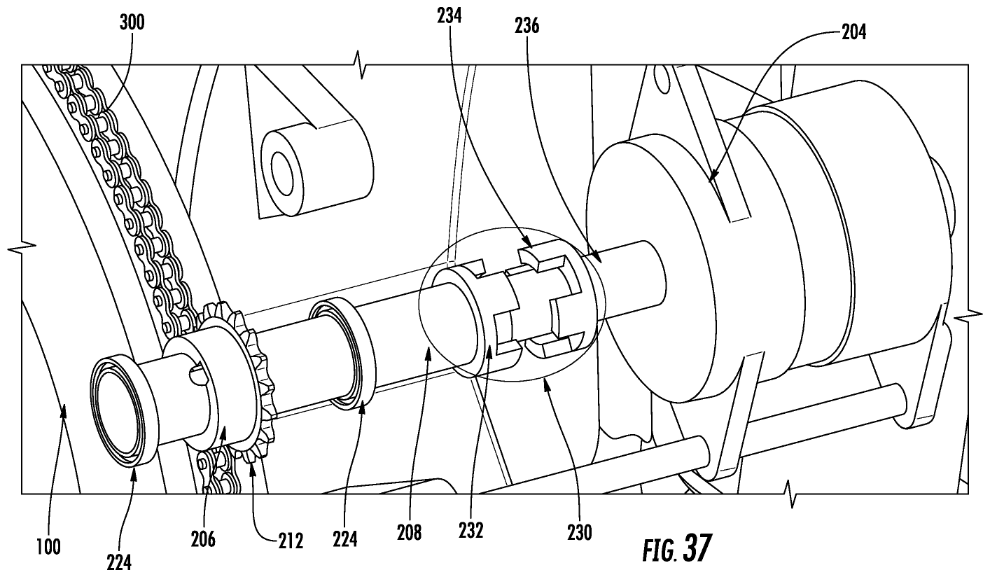

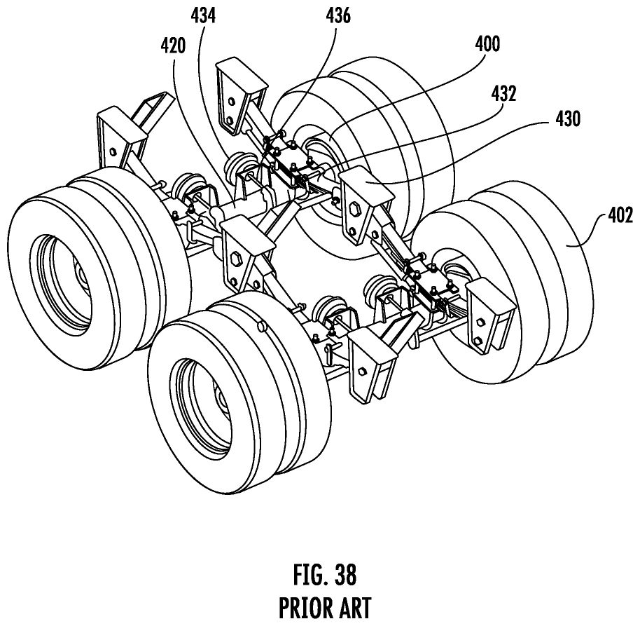

Referring to FIGS. 2-37, various embodiments of the energy generation system 200 are shown as having a generator 204, a mechanical coupler 206, a connecting member 208 and an energy storage system 210. In both front and rear wheel configurations the system 200 fits within the wheel area, with those in front being able to rotate with wheel movement.

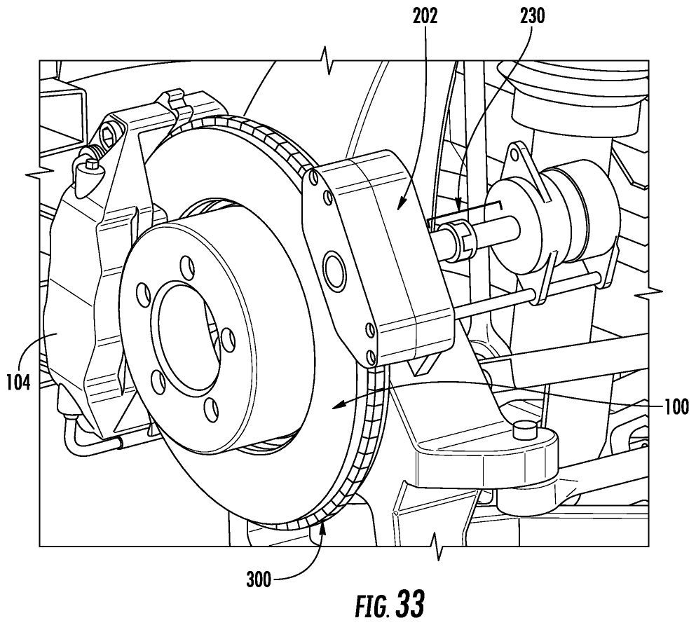

Referring to FIGS. 2-3, 21 and 29A-C, the mechanical coupler 206 is shown as a sprocket or gear having a plurality of teeth 212 spaced apart its circumference and sized and shaped to engage the corresponding ventilating slots 102 on the disc brake rotor 100. In an alternate embodiment (FIGS. 33-37), the coupler 206 engages openings in a roller chain 300 that is placed around the edge of the disc brake rotor 100, facilitating the rotation. Referring to FIG. 19, in order to facilitate the mechanical connection of the chain 300 to the disc brake rotor 100, the spokes or elongated members 214 forming the ventilating slots 102 have tapered ends 216 for engaging openings in the chain 300.

The mechanical coupler 206 is connected to a shaft or axle 208 through its center. In order to maintain the coupler 206 in position relative to the disc brake rotor 100, a bracket 202 may be used. Similar to the disc caliper 104 in operation, the bracket 202 remains parallel to the disc brake surface. In order to not interfere with the operation of the disc brake, the coupler 206 and bracket 202 are placed apart from the caliper 104 about the disc brake rotor 102.

Referring again to FIG. 2, the bracket 202, having a hollow interior defined by pair of side walls 220, is positioned astride of the disc brake rotor 100. Opposing holes 222 extend through the side walls 220 for receiving a portion of the axle or shaft 208 therethrough to allow the coupler 206 to be aligned with the ventilating slots 102. As shown in FIG. 16, bushings 224 may be inserted into the holes 222 to facilitate rotation of the axle 208.

The axle 208 is connected to the generator 204 for generating energy in the form of either alternating current (“AC”) or direct current (“DC”). The energy is then transmitted and/or stored in an energy storage component or system that may be locally positioned with the generator or is part of the vehicle's energy system. This may include feeding into the alternator/battery bus, and/or into a separate vehicle electronics circuitry.

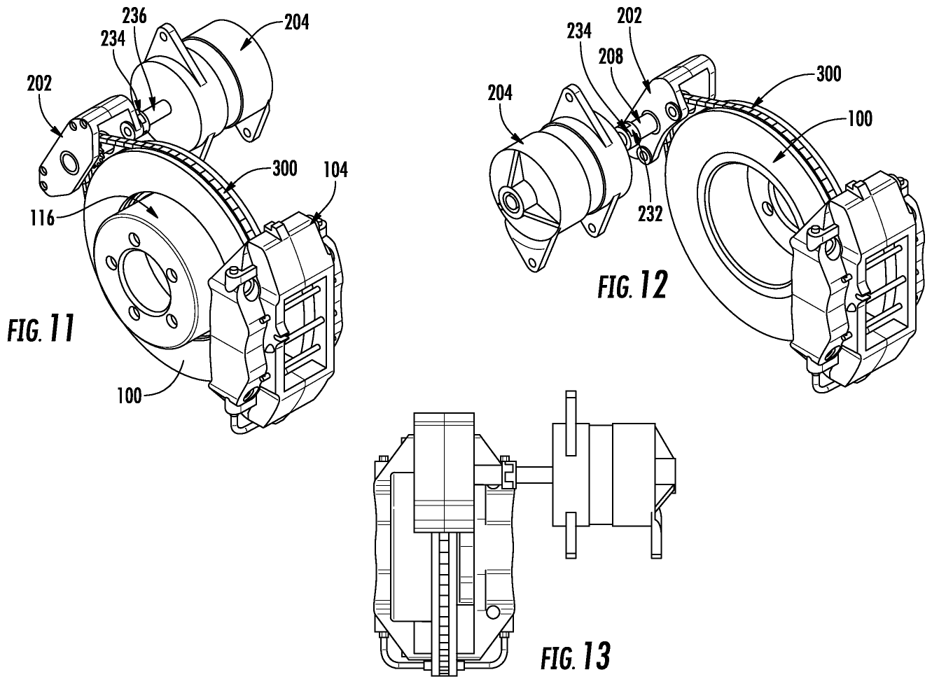

Referring now to FIGS. 13, 23-24, 27-28 and 31-33, the energy generation system 200 may be equipped with a clutch 230 to only generate energy when desired or needed. The positive clutch 230 shown in the figures includes a jaw member 232 on the end of the axle 208 and a corresponding jaw member 234 positioned on a driven shaft 236 for the generator 204. When the clutch 230 is engaged, the corresponding jaw members 232, 234 are engaged to allow for the transmission of the rotational movement to the generator 204. When disengaged, the axle 208 will rotate without transmitting energy to the generator 204. Similarly, the generation of energy may be electronically shunted, so the load is minimal when not generating energy.

In operation, one or more teeth 212 from the sprocket 206 engage respective slots in the ventilating slots 102 of the disc brake rotor 100. As the disc brake rotor 100 is rotated, the sprocket 206 and axle 208 will also rotate as the teeth 212 of the sprocket 206 are moved out of and into engagement with the slots 102. Thus, as the wheel moves, the disc brake rotor 100 moves, and the axle 208 going to the generator moves thereby creating energy to be stored in the vehicle. If desired, the clutch 230 may be utilized to selectively permit control of the transmission of the energy to the generator 204.

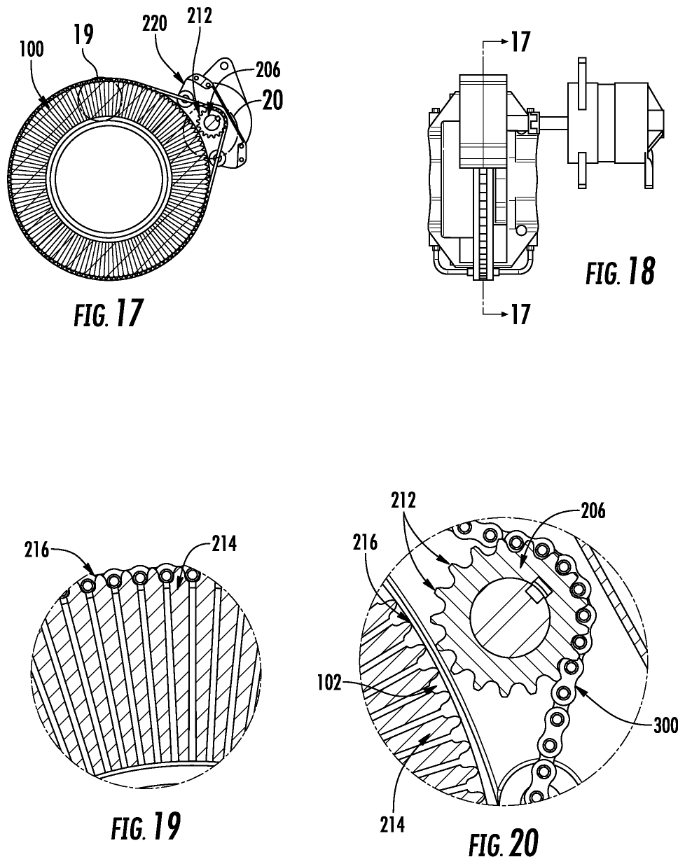

FIGS. 11 to 20 show another embodiment of the present invention utilizing a chain 300 to transmit rotational energy from the disc brake rotor 100 to the coupler or sprocket 206. In this embodiment, the sprocket 206 is offset from the disc brake rotor 100. Referring to FIGS. 19-20, the ventilating slots 102 are formed by a plurality of spokes or elongated members 214 having tapered ends 216. The chain 300 extends around both a substantial portion of the circumference of the disc brake rotor 100, engaging the tapered ends 216 thereon, and a portion of the sprocket 206, thereby engaging the teeth 212 on the sprocket. Referring to FIG. 14, a clutch 230, as disclosed above, may be used to selectively control transmission of the energy to the generator 204.

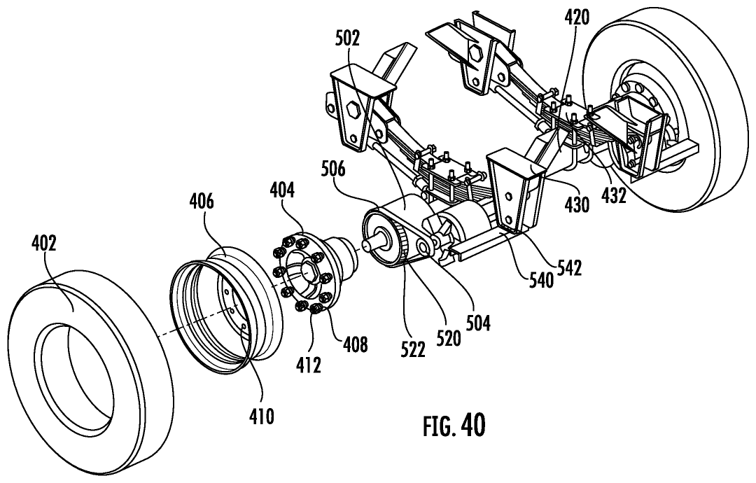

Referring to FIG. 38, a drum brake system as presently embodied in the prior art is shown as utilizing drum brakes on each set of wheels for a heavy duty truck or vehicle. The drum brake includes a rotating cylinder or drum 400 that is attached to the wheel hub 404 of the wheel 402, or in the case of larger or heavy duty vehicles, to a paired set of wheels. The wheel hub 404 is attached to and rotates with the axle 420. Referring to FIG. 40, in one embodiment, a rim 406 fits within the wheel 402 and is attached to the vehicle through a series of bolts 408 of the wheel hub 404 that extend through corresponding holes 410 in the rim 404. Lug nuts 412 then may be placed over the bolts 408 and rotationally tightened to secure the wheel 402 to the vehicle. When the brakes are applied, a wheel cylinder activates pistons that push a pair of opposed brake shoes outwardly against the inside of the drum. The shoes each include a friction liner such that when the shoes engage the drum, they apply friction to slow and stop rotation of the drum and, thus the wheel.

The drums 400 are attached to the respective axle 420 so that they rotate with the wheels 402. The frame is shown as including a number of side members 430 and a leaf spring suspension system that includes leaf springs 432 extending between the side members 430 to provide for suspension of the vehicle. Pneumatic brake compressors 434 are used to provide pneumatic brake fluid through tubing 436 to actuate the cylinder. While a particular frame and spring system is shown, it is appreciated that the present invention may be utilized with other vehicles systems utilizing drum brakes.

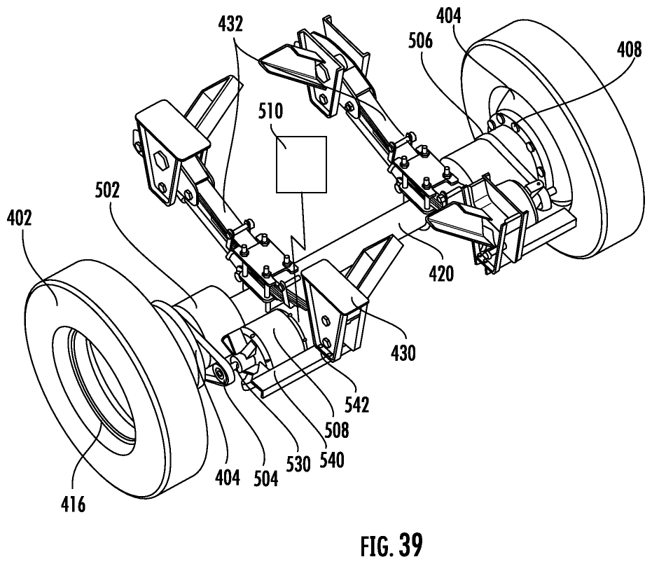

Referring to FIGS. 39-41, various embodiments of the energy generation system 500 for use with a drum brake are shown as having a drum 502, a coupler member 504, a rotational conveyor 506, an energy transformation component 508 and an energy storage system 510. While the system is shown as being used in connection with a drum, it is appreciated that it may be used with any rotating party of a vehicle, including, but not limited to, the axles.

Referring to FIGS. 39-41, the coupler member 504 is shown as a sprocket or gear having a plurality of teeth 512 spaced apart its circumference that engage corresponding teeth or raised surfaces 514 on the rotational conveyor 506, which is shown as being a belt. It is appreciated that the rotational conveyor may be a variety of known rotational conveyors for engaging the drum and coupler member and not depart from the scope of the present invention. As an example, as shown in FIG. 36, the rotational conveyor 506 could be a roller chain 300 wherein the teeth 512 of the coupler member 504 engage openings in the roller chain.

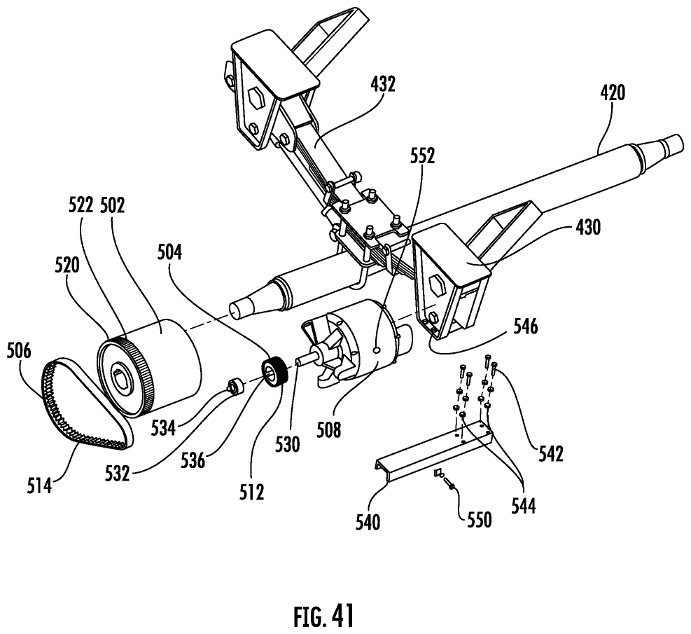

The rotational conveyor 506 also engages corresponding a corresponding surface 520 on the periphery of the drum 502. Referring to FIGS. 40-41, the corresponding surface 514 on the drum 502 is shown as raised members or teeth 522. It is appreciated that the raised members 522 may be formed directly onto the drum 502 or attached as a strip to the periphery of the drum 502 through soldering, adhesives or other known means. It is appreciated that the corresponding drum surface 520 may also be a variety of other different surfaces for engaging the rotational conveyor 506 including, but not limited to friction surfaces. While the teeth are shown as extending around the periphery of the end of the drum, it is appreciated that they may be located elsewhere along the length of the drum depending on the location and position of the drum and other components.

The coupler member 504 is connected to a shaft or axle 530 through its center. An insert 532 may be utilized to connect the coupler member 504 to the shaft 530. One embodiment of the insert 532 is shown as being an annular ring having a tongue 534 on its exterior surface that fits within a corresponding groove 536 on the inside of the coupler member 504. The coupler member 504 may be attached directly or through the insert 532 to the shaft 530 through screws, press fit or other known methods.

The shaft 530 is connected to the energy transformation component 508 for generating energy in the form of either alternating current (“AC”) or direct current (“DC”). The energy transformation component may be a generator such as an alternator. The energy is then transmitted and/or stored in an energy storage component 510 or system that may be locally positioned with the generator or a part of the vehicle's energy system. This may include feeding into the alternator/battery bus and/or into a separate vehicle electronics circuitry. For example. The energy may be stored in one or more batteries positioned in the vehicle and/or trailer or other member attached to the vehicle.

In order to retain the generator 508 and coupler member 504 in position relative to the drum 502, the generator 508 may be attached to a generator frame 540 that is attached to the vehicle frame 430 or other component. Referring to FIG. 41, the generator frame 540 may be a U-shaped beam that connected to the vehicle frame side member 430 using a plurality of bolts 542 and nuts 544 that attach through openings 546. While bolts and nuts are shown, it is appreciated that the generator frame may be attached to the vehicle or its frame using other known methods including, but not limited to, soldering. The generator 508 may be attached to the frame using a bolt or screw 550 through a threaded opening 552 on the generator 508, a bracket or other known means.

In operation, when the drum 502 rotates, the teeth 522 extending around the periphery of the drum 502 engage the corresponding teeth 514 of the rotational conveyor 506 so that the rotational conveyor 506 also rotates. As the rotational conveyor 506 rotates, the coupler member 504 will also rotate as the teeth 512 of the coupler member 504 move in and out of engagement with the corresponding teeth 514 506of the rotational conveyor. Rotation of the coupler member 504 will also rotate the shaft 530 to the generator 508 thereby creating energy to be stored in the vehicle. If desired, a clutch may be utilized to selectively permit control of the transmission of energy to the generator 508.

In concluding the detailed description, it should be noted that it would be obvious to those skilled in the art that many variations and modifications can be made to the embodiment without substantially departing from the principles of the present invention. Also, such variations and modifications are intended to be included herein within the scope of the present invention as set forth in the appended claims. Further, in the claims hereafter, the structures, materials, acts and equivalents of all means or step-plus function elements are intended to include any structure, materials or acts for performing their cited functions.

It should be emphasized that the above-described embodiments of the present invention, particularly any “suggested embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention and protected by the following claims.

The present invention has been described in sufficient detail with a certain degree of particularity. The utilities thereof are appreciated by those skilled in the art. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

1. A system for the generation of energy in a vehicle having a drum brake and a frame, the system comprising:
a drum having a periphery;
a coupler member;
a rotational conveyor that extends between and operatively connects the drum and the coupler member; and
a generator operatively connected to the coupler member.

2. The system of claim 1 wherein the generator comprises a connecting member that mechanically connects the generator to the coupler member.

3. The system of claim 1 wherein the periphery of the drum includes raised surfaces and the coupler member includes raised surfaces for engaging the rotational conveyor.

4. The system of claim 3 where the raised surfaces are teeth.

5. The system of claim 3 where the rotational conveyor includes corresponding raised surfaces for engaging the raised surfaces of the drum and the coupler member.

6. The system of claim 1 wherein the periphery of the drum and the coupler member include a friction surface.

7. The system of claim 1 which further comprises a frame member that maintains the generator and coupler member in position relative to the drum.

8. The system of claim 1 wherein the rotational conveyor comprises a chain.

9. The system of claim 1 wherein the generator is an alternator.

10. The system of claim 1 which further comprises an energy storage system electrically connected to the generator for storing energy generated by rotation of the drum.

11. A system for the generation of energy in a vehicle having a drum brake and a frame, the system comprising:
a drum having a periphery having raised surfaces;
a coupler member having raised surfaces;
a rotational conveyor that extends between and operatively connects the drum and the coupler member;
a generator operatively connected to the coupler member; and
a frame member that maintains the generator and coupler member in position relative to the drum.

12. The system of claim 11 wherein the generator is an alternator.

13. The system of claim 11 which further comprises an energy storage system electrically connected to the generator for storing energy generated by rotation of the drum.

14. The system of claim 11 wherein the raised surfaces are teeth.

15. The system of claim 14 wherein the rotational conveyor includes corresponding teeth for engaging the teeth of the drum and coupler member.

16. The system of claim 14 wherein the rotational conveyor is a chain.

17. The system of claim 14 wherein the rotational conveyor is a belt.
